(19) United States
(12) Patent Application Publication
(10) Pub. No.: US 2019/0274343 A1
(43) Pub. Date: Sep. 12, 2019

(54) ALKALINE COAGULANT FOR KONNYAKU PRODUCTION, PRODUCTION METHOD FOR KONNYAKU, AND KONNYAKU PRODUCT

(71) Applicant: ORIHIRO Plantdew Co., Ltd., Takasaki-shi, Gunma (JP)

(72) Inventors: Orihiro TSURUTA, Takasaki-shi, Gunma (JP); Masaru MATSUURA, Takasaki-shi, Gunma (JP)

(73) Assignee: ORIHIRO Plantdew Co., Ltd., Takasaki-shi, Gunma (JP)

(21) Appl. No.: 16/328,960

(22) PCT Filed: Sep. 2, 2016
(86) PCT No.: PCT/JP2016/075846

§ 371 Date: Feb. 27, 2019

(51) Int. Cl. A23L 19/10; A23P 10/10; A23P 30/38; A23P 10/47

(52) U.S. Cl. CPC A23L 19/115; A23P 10/47; A23P 30/38; A23P 10/10

(57) ABSTRACT

An object of the present invention is to provide a konnyaku product in which scum causing smell and unpleasant taste is effectively reduced and that does not require a pretreatment for removing them, a production method therefor, and an alkaline coagulant suitable for the production of such a konnyaku. The object can be achieved by using, as an alkaline coagulant for konnyaku production, an alkaline solution containing non-reducing sugar, calcium hydroxide as an alkaline component for coagulation, and water, in which the non-reducing sugar and the calcium hydroxide are dissolved in the water.

### TECHNICAL FIELD

The present invention relates to an alkaline coagulant for konnyaku production, a production method for a konnyaku, and a konnyaku product.

### BACKGROUND ART

Generally, a konnyaku or konjac product as a jelly like-food is produced by an alkaline treatment with an alkaline coagulant and a heating treatment, using konnyaku mannan contained in the corm (commonly called as konnyaku potato or konnyaku bulb) of konjac, which is a plant of the Araveae family, as a raw material. Konnyaku products are traditional foods that have been eaten in Japan since ancient times, and it can be said that konnyaku products are very excellent food, because konnyaku products have low calorie content and also function as dietary fiber.

The use of the alkaline coagulant also has the effect of preventing microbial contamination and increasing preservability under the condition that the konnyaku product has a high-alkaline pH.

However, the konnyaku product contains scum that causes unpleasant tastes other than the original taste of konnyaku, such as astringent or harsh taste and bitterness. Further, the smell of the konnyaku product is sometimes avoided by consumers, and when the smell is strong, it is sometimes difficult to perform an intended seasoning and cooking. Therefore, it is often necessary to perform a pre-treatment for removing the smell and the scum before cooking.

Traditionally, a method of soaking konnyaku in cold water, salt sprinkling, tapping konnyaku on a chopping board with a wooden pestle, etc., are performed as a scum removal method, and a method of soaking konnyaku in water, a method of performing a boiling water treatment, etc., is performed as a method for eliminating the konnyaku smell.

In the case where calcium hydroxide is used as an alkaline component of the alkaline coagulant, since calcium hydroxide is poorly soluble in water, calcium hydroxide needs to be added in a konnyaku paste in the state of a solid-mixed suspension, and calcium hydroxide remains in the solid state in the konnyaku product without being completely dissolved in the konnyaku paste. As a result, it is thought that, when konnyaku is directly cooked without a pre-cooking, such direct cooking causes konnyaku smell and astringent or harsh teste.

In recent years, the number of families who do not have enough time for cooking increases, and cooking of konnyaku products that require the troublesome scum removal tends to be avoided.

Patent Literature 1 discloses a production method of konnyaku from which unusual smell is eliminated, which comprises preparing a paste by adding one or more selected from reducing sugars (glucose, fructose, maltose, lactose, xylose, arabinose, galactose, etc.) to the paste and heating the paste after addition of a gelatinizer, when konnyaku is produced by adding water to konnyaku potato or its powder to prepare a paste and mixing a salt of calcium, potassium or sodium as a gelatinizer to the paste.

In Patent Literature 1, it was presumed, as the reason why an amine smell as the unusual smell of konnyaku could be eliminated using the reducing sugar, that proteins contained in the konnyaku potato reacted with excessively existing alkaline components. Patent Literature 1 describes that the invention was carried out based on the presumption that the unusual smell could be eliminated due to the binding of proteins by the reaction with the reducing sugar under a strong alkaline condition, so that the predicted effect could be obtained.

### CITATION LIST

### Patent Literature

Patent Literature 1: Japanese Patent Laid-Open No. 103230/1996 as JP08-103230A

### SUMMARY OF INVENTION

### Technical Problem

However, in Patent Literature 1, the object is to eliminate the unusual smell by the reaction of proteins derived from the konnyaku potato with alkalis. Patent Literature 1 using a lime suspension as the coagulant does not present any solution to the problem that the scum and the smell are generated due to the solid calcium hydroxide remaining in the konnyaku product.

An object of the present invention is to provide a konnyaku product in which the scum causing the smell and unpleasant taste due to the solid calcium hydroxide remaining in the konnyaku product is effectively reduced, and that does not require a pretreatment for removing them; a production method therefor; and an alkaline coagulant suitable for the production of such a konnyaku.

Another object of the present invention is to provide a production method for a konnyaku that allows a valid and effective use of calcium hydroxide as the alkaline component of the alkaline coagulant, and that directly promotes the gelation of the konnyaku paste; and an alkaline coagulant to be used therein.

Another object of the present invention is to allow an efficient use of calcium hydroxide as the alkaline component of the alkaline coagulant in the konnyaku production.

Another object of the present invention is to allow an effective and efficient use of calcium hydroxide as a filler water in the konnyaku product, for example, a packaged konnyaku product resulting from processing a konnyaku produced prepared by using an alkaline coagulant according to the present invention, or a packaged konnyaku product resulting from processing a konnyaku produced using a conventional lime suspension.

### Solution to Problem

An alkaline coagulant for konnyaku production according to the present invention comprising

an alkaline solution comprising sugar, calcium hydroxide as an alkaline component for coagulation, and water, wherein the sugar and the calcium hydroxide are dissolved in the water, and the sugar is non-reducing sugar.

A production method for a konnyaku according to the present invention comprising a step of mixing a konnyaku paste with an alkaline coagulant and coagulating the konnyaku paste, wherein the alkaline coagulant having the above composition is used as the alkaline coagulant to be mixed with the konnyaku paste.

A packaged konnyaku product according to the present invention is a packaged konnyaku product including at least one of a konnyaku and a processed product thereof, and a filler water, filled in a container for packaging,

wherein the filler water comprising an alkaline solution containing sugar, calcium hydroxide as an alkaline component for coagulation, and water, wherein the sugar and the calcium hydroxide are dissolved in the water, and the sugar is non-reducing sugar.

As the at least one of the konnyaku and the processed product thereof to be filled together with the filler water in the container for packaging, at least one may be used, which is selected from a konnyaku and a processed konnyaku product thereof produced by using the alkaline coagulant in the above composition according to the present invention; and a konnyaku and a processed product thereof produced by a conventional method.

### Effects of Invention

According to the present invention, by producing a konnyaku using an alkaline coagulant in which a necessary amount of calcium hydroxide as an alkaline component for coagulation is dissolved in the coexistence with sugar and in which the solid component of calcium hydroxide is not contained, it is possible to obtain a konnyaku product in which the scum causing the smell and unpleasant taste due to the solid calcium hydroxide remaining in the konnyaku product is effectively reduced, and, therefore, no pretreatment for removing the scum is required.

According to the present invention, it is possible to use a necessary amount of calcium hydroxide in the dissolved state in an aqueous solution, and it is possible to suppress an excessive input of calcium hydroxide as the solid component, and to facilitate the control of pH at the time of the coagulation by the mixing with the konnyaku paste. As a result, an efficient and effective use of the calcium hydroxide as an alkaline coagulant component can be provided.

Furthermore, according to the present invention, by using an aqueous solution containing the non-reducing sugar and calcium hydroxide in the dissolved state as the filler water in the packaged konnyaku product, it is possible to effectively and efficiently use calcium hydroxide as a component of the filler water in the packaged konnyaku product.

These points are very useful in the manufacturing and distribution of industrially made konnyaku products.

### BRIEF DESCRIPTION OF DRAWINGS

FIG. 1 is a graph showing the relation between the calcium hydroxide concentration added to the sucrose solutions having various sucrose concentrations, respectively, and the calcium hydroxide concentrations dissolved in the sucrose solutions, respectively.

FIG. 2 is a graph showing the relation between the calcium hydroxide concentration added in a 6% sucrose solution and the calcium hydroxide concentration in a supernatant part.

FIG. 3 is a graph showing the relation between the calcium hydroxide concentration added in a 20% sucrose solution and the calcium hydroxide concentration in a supernatant part.

FIG. 4 is a graph showing the relation between the dissolution temperature in the 6% sucrose solution and the dissolution temperature of calcium hydroxide.

FIG. 5 is a graph showing the relation between the calcium hydroxide concentration in a konnyaku and pH of the konnyaku.

### DESCRIPTION OF EMBODIMENTS

The inventors have intensively studied a production method for a konnyaku that has reduced smell and astringent or harsh taste, that does not require the elimination process for removal of smell and astringent or harsh taste, and that can easily be cooked. Furthermore, the inventors have intensively studied the development of a technology allowing further efficient use of calcium hydroxide as an alkaline component contained in an alkaline coagulant to produce konnyaku having reduced smell and astringent or harsh taste.

As a result, the inventors have reached to the conclusion that, when a calcium hydroxide suspension having a concentration necessary for konnyaku production can be changed to a calcium hydroxide solution containing no solid component of calcium hydroxide, it can make the konnyaku free from remaining calcium hydroxide as the solid component and, thus, the removal step of smell and astringent or harsh taste becomes unnecessary.

Furthermore, the inventors have reached to the conclusion that, when it is made possible to provide an alkaline coagulant containing no solid component of calcium hydroxide and calcium hydroxide at a high concentration, which has an excellent preservation stability, calcium hydroxide as an alkaline component in a alkaline coagulant for konnyaku production can be further efficiently used and, thus, a technology that is very useful in industrial high-volume manufacturing can be provided.

In the konnyaku production in Patent Literature 1 using a method of removing konnyaku smell, although konnyaku smell elimination effect can be obtained by the reducing sugar, a conventional lime suspension is still used as the alkaline coagulant. Therefore, even in the method disclosed in Patent Literature 1, there is still a technical problem concerning the reduction of the generation of smell and astringent or harsh taste due to the remaining solid component of calcium hydroxide in the konnyaku.

The inventors have further studied whether or not a calcium hydroxide aqueous solution can be used as an alkaline coagulant for konnyaku production, which has an improved the solubility of calcium hydroxide in water due to the coexistence with sugar.

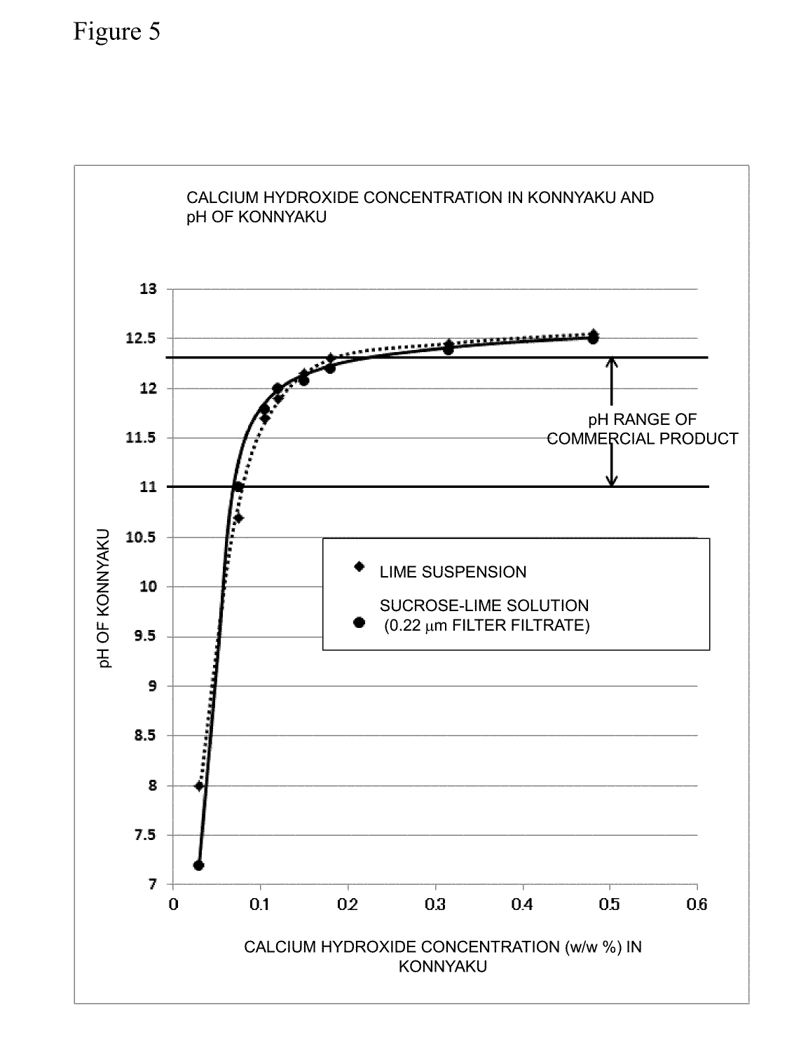

Regarding a calcium hydroxide solution (sucrose-lime solution) in which calcium hydroxide is dissolved in a solution of sucrose as a non-reducing sugar, konnyaku production tests were performed on the basis of the calcium hydroxide amount converted from the measurement value of the calcium amount in the solution. Also regarding hydrated lime used for comparison, the calcium amount was measured, and the calcium hydroxide amount was calculated from the calcium amount. As a result, as shown in FIG. 5, it was revealed that the sucrose-lime solution had pH adjustment function equivalent to the lime suspension in the konnyaku paste and effectively acts as the alkaline component. Based on this result, the inventors have reached to the conclusion that the calcium hydroxide aqueous solution having an improved solubility in water by the existence of the non-reducing sugar can be validly used as the alkaline component of the coagulant for the konnyaku production, and the inventors have completed the present invention.

Thus, the present invention saves the labor of the pretreatment that is troublesome for consumers, for example, removal of konnyaku smell and astringent or harsh taste, and the present invention leads to a wide utilization of konnyaku as a more familiar foodstuff.

The present invention has an object to provide a simple, delicious and novel konnyaku product adapted to the modern dietary life. This object is achieved according to the present invention by improving the solubility of calcium hydroxide contained as the alkaline component of the alkaline coagulant in the coexistence with sugar so that calcium hydroxide can be used at a concentration necessary for konnyaku production.

The alkaline coagulant for the konnyaku production according to the present invention comprises an alkaline solution comprising sugar, calcium hydroxide as an alkaline component for coagulation, and water, in which the sugar and the calcium hydroxide are dissolved in water.

The sugar to be used as the component of the alkaline coagulant needs to have a function to improve the solubility of calcium hydroxide without influencing an intended effect as the coagulant. From such a standpoint, a non-reducing sugar is used as the sugar in the present invention.

It is reasonable thinking that calcium hydroxide can be dissolved with one of monosaccharide, disaccharide, trisaccharide, oligosaccharide and polysaccharide usable as the alkaline coagulant for konnyaku production, because it is known that calcium hydroxide dissolves in a sugar solution (Kagaku Daijiten, p 1170, issued in 1998, Michinori Ooki et al., Tokyo Kagaku Dojin). However, it was found that calcium hydroxide cannot be used for the object of the present invention together with a reducing sugar, because calcium hydroxide is a strong base and causes a so-called browning reaction.

For example, a 0.22 μm filter filtrate (hereinafter, referred to as glucose-lime solution) including calcium hydroxide dissolved in a 10% by mass glucose solution had pH of 12.44, and the calcium hydroxide concentration converted from the Ca amount by an atomic absorption spectrophotometer was 3.47% by mass. A konnyaku paste was prepared by adding 5 g of a konnyaku powder (special grade powders) to 175 g of tap water and stirring the mixture for 8 minutes and leaving the mixture to still stand at room temperature for 1.5 hours for sufficient swelling. Then, 5.76 g of a 10% by mass glucose-lime solution was diluted with water to 20 g (1% by mass solution in terms of calcium hydroxide). The diluted solution was mixed with the konnyaku paste and the resultant paste was kneaded. The kneaded paste was packaged and heated at 80° C. for 30 minutes, and, thereafter, the packaged paste was left at room temperature overnight, so that the coagulation proceeded sufficiently. The resultant konnyaku had pH of 9.4, which was neither equal to nor higher than the predetermined pH of 11.0. Its texture was strongly sticky, and it is seemed that the texture could not respond to a demand for the texture to be easily-bitten. Such pH 9.4 was almost the same as that in the case of the use of a lime suspension having a calcium hydroxide concentration of 0.5%. Therefore, regarding the calcium hydroxide dissolved in the glucose solution, it was thought that the ratio of the contribution to the gelation of the konnyaku paste was about 50%, and the use efficiency was low. Further, the 10% by mass glucose-lime solution was put in a container with an airtight stopper, and was preserved under a temperature condition of 40° C. As a result, browning of the solution proceeded on the first day, the muddiness was generated on the second day, the precipitation generation started on the third day, and, after that, the browning and the precipitation generation further proceeded. After that, the browning and the precipitation generation further proceeded, and the solution was a very unstable solution.

In view of the above result, the inventors have reached to the conclusion that it is preferable to use non-reducing sugar as the sugar component.

As the non-reducing sugar, sucrose (saccharose) and trehalose can be exemplified in light of easy availability. Sucrose is more preferable, because dissolution ability of calcium hydroxide and stability are high, as the alkaline agent for calcium hydroxide to be dissolved with the sugar. Various sugar products such as commercially available granulated sugar and white superfine soft sugar can be used as sucrose. The white superfine soft sugar sometimes contains a small amount of invert sugar (reducing sugar) that causes brown discoloration, and it is preferable to use granulated sugar.

The calcium hydroxide to be used as the alkaline component is not particularly limited if it can be used for the application to foods. Hydrated lime to be obtained from limestone is useful from the standpoint of the reduction of production cost in industrial high-volume manufacturing.

The alkaline aqueous solution as the alkaline coagulant can be prepared by various methods including a method comprising adding calcium hydroxide to water with sugar and performing stirring and mixing; a method comprising adding an excessive amount of calcium hydroxide to sugar aqueous solution containing dissolving sugar, performing stirring and mixing, and, thereafter, removing an insoluble fraction, etc.

The solubility of calcium hydroxide in the coexistence with sugar also changes depending on the preparation temperature of the aqueous solution. Generally, the dissolution concentration of calcium hydroxide in an aqueous solution having the same sugar concentration is inversely proportional to the temperature. Therefore, a lower temperature allows calcium hydroxide to be dissolved at a higher concentration. Further, depending on conditions such as sugar concentration and temperature, the dissolution concentration of calcium hydroxide cannot be sometimes accurately predicted. In such a case, an alkaline aqueous solution is prepared after an excessive amount of calcium hydroxide is added, and, then, the solid component remaining in the prepared aqueous solution is separated. The clear solution thus obtained can be used as the alkaline coagulant. The separation of the solid component may to be performed by obtaining the supernatant after leaving it to still stand. It is more preferable that minute floating particles be further removed by a known separation method such as a centrifugal separation, a membrane filtration and a fining treatment with use of a filter aid. Thus, it is more preferably to use the alkaline coagulant as a so-called transparent solution be used.

When the alkaline aqueous solution as the alkaline coagulant is prepared, the input amount of sugar may be that allowing an intended dissolution concentration of calcium hydroxide to be achieved. However, there is a case that, when the sugar solution has a high concentration, formation of the insoluble calcium hydroxide is inhibited, and adjustment of the concentration of calcium hydroxide to be dissolved is required. Further, in the case of 35%, there is a case that obstacles such as generation of an adhesive product due to agglutination of the added calcium hydroxide occurs sometimes. Therefore, the sugar concentration in water may be selected from a range of 1 to 30% by mass, preferably 2 to 20% by mass, further preferably 5 to 15%.

The concentration of calcium hydroxide in the dissolved state that is contained in the alkaline aqueous solution as the alkaline coagulant may be that amount allowing an intended function and preservation stability as the alkaline coagulant to be obtained, at the temperature to be used in the konnyaku production. However, there is a case that, when the calcium hydroxide concentration to be dissolved in the sugar solution is exceeding 6.5%, the formation of the insoluble calcium hydroxide and, thus, the solid-liquid separation become difficult, in some cases. Therefore, the range of 0.25% by mass to 6.5% by mass is preferable.

The preparation temperature of the alkali aqueous solution as the alkaline coagulant may to be that allowing an intended function and preservation stability as the alkaline coagulant to be obtained, at a useable temperature in the konnyaku production, and there is no particular restriction. The preparation temperature can be selected from 5° C. to 70° C., for example, a cooling temperature of 9 to 11° C., or a normal room temperature of 21 to 25° C.

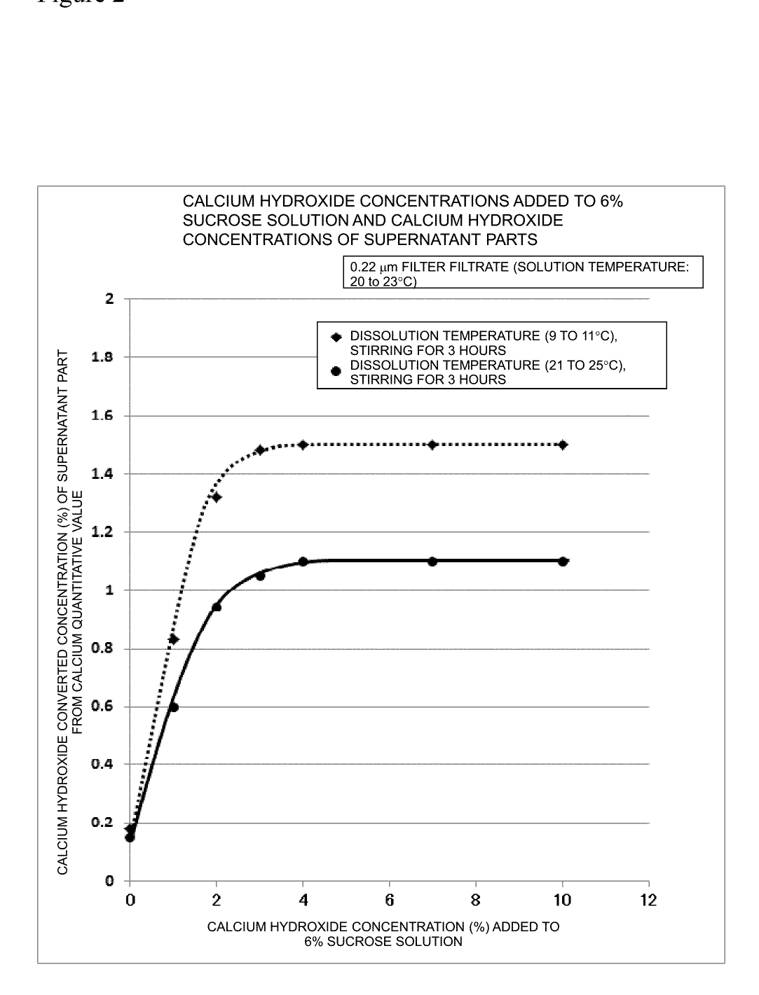

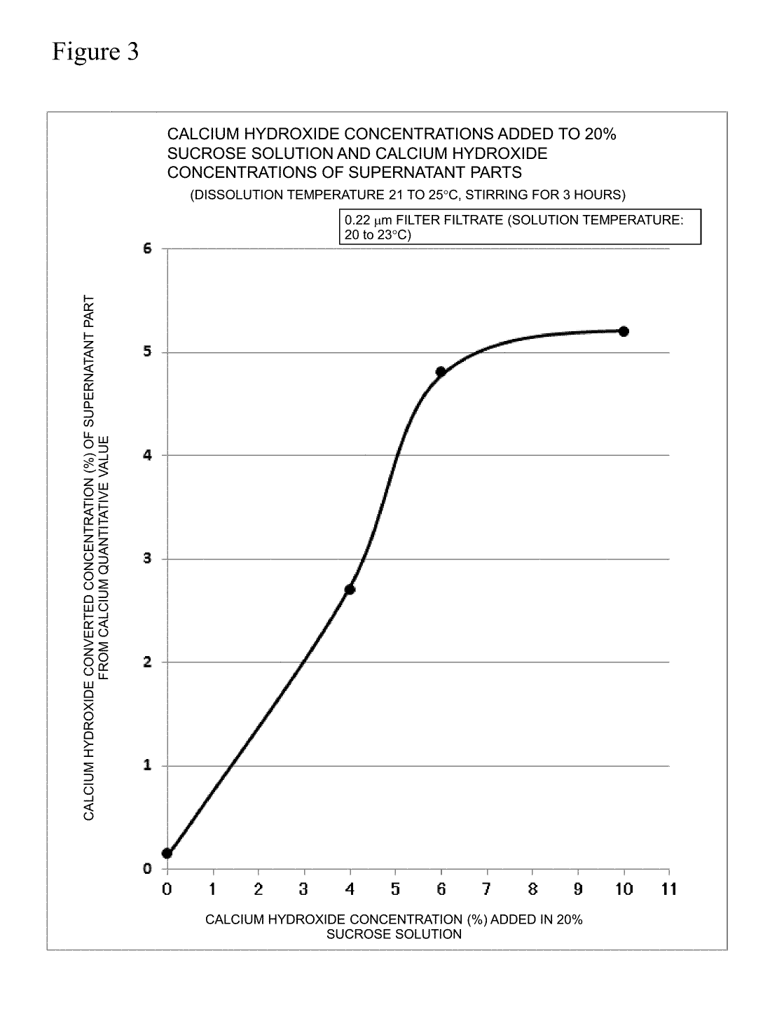

The preferable input amount of calcium hydroxide in the coexistence of sugar at the preparation temperature is an amount of 2 to 4 times (by weight) to its solubility (FIG. 2, FIG. 3).

The alkaline coagulant itself may have an alkaline property allowing an intended coagulant function as the alkaline coagulant to be obtained. For example, the alkaline coagulant can have an alkaline property with a pH that is selected from a range of 12 to 13, preferably 12.0 to 12.8, more preferably 12.3 to 12.8.

The alkaline coagulant consisting of an aqueous solution of sugar and calcium hydroxide according to the present invention is very stable under a temperature condition for keeping the state of an aqueous solution having 50° C. or lower. The alkaline coagulant can be prepared in a high volume and can be hermetically stored is a sealed state. The stored solution can be diluted if necessary for its use. The amount to be used can be regulated depending on the manufactured amount of the konnyaku. Therefore, the value of the alkaline coagulant is high in light of industrial use.

Because of the coexistence with the non-reducing sugar, the alkaline coagulant according to the present invention contains no solid component of calcium hydroxide, while the alkaline coagulant contains calcium hydroxide at a high concentration with an excellent preservation stability. Therefore, it is possible to stock the alkaline coagulant produced in a large volume and use it at a necessary timing. Thus, it is possible to achieve an efficient use of calcium hydroxide at the time of the konnyaku production.

The konnyaku product according to the present invention is produced by using an alkaline aqueous solution in which the above-described non-reducing sugar and calcium hydroxide are dissolved in water, as the alkaline coagulant.

Examples of the konnyaku product according to the present invention include a konnyaku product called “Namazume” as a Japanese word by gelation of konnyaku paste within a container for package; and a packaged konnyaku product including at least one of the konnyaku and the processed konnyaku product thereof with filler water filled in a container for packaging.

The shapes of the konnyaku and the processed konnyaku product thereof are not particularly limited. Examples of the shapes of konnyaku may include a rectangular shape, a round shape, a spherical shape, a rhombic shape, a bar shape, etc. Each shape of konnyaku can be obtained by a method of coagulating a konnyaku paste containing the alkaline coagulant, while forming the konnyaku paste into an intended shape such as “Tamakonnyaku” as a kind of ball-shape konnyaku and “Shirataki” as a fine noodle type konnyaku; or by a method of producing a processed konnyaku product by cutting or dividing a konnyaku mass having a block shape, a plate shape, etc., into an intended shape, such as a threadlike konnyaku and konnyaku product having various shapes.

The production of the konnyaku using the above-described alkaline coagulant can be performed as follows:

First, a konnyaku material and water are mixed and kneaded, and the mixture thus obtained was warmed if necessary, so that a konnyaku paste, in which the konnyaku raw material is swelled, is prepared.

As the konnyaku raw material, various konnyaku raw materials that have been used for the production of the konnyaku can be used. Examples of the konnyaku raw material include a raw material resulting from processing of a konnyaku potato (bulb) by a method such as knifing, milling and grinding, processed and treated products thereof; refined powders and coarse powders obtained from a konnyaku potato (bulb); and processed and treated products thereof.

In the konnyaku paste, at least one selected from soy milk, tofu, fish meat, meat, seaweeds, seasoning, spices, extracts and aroma chemicals can be previously blended depending on the cooking application of the konnyaku products.

Next, the alkaline coagulant according to the present invention is added to the konnyaku paste, and the kneading and the heating are performed, so that the konnyaku paste is coagulated. Furthermore, treatments such as forming and aqueous cleaning are performed by a conventional method, so that the konnyaku product can be obtained. When the temperature at the time of the mixing of the alkaline coagulant with the konnyaku paste is 70° C. or lower, no precipitation of calcium hydroxide occurs during the kneading step, and it is possible to prevent the generation of the smell and scum caused by the solid component of the calcium hydroxide.

The amount of the alkaline coagulant to be added to a konnyaku paste may be set such that an intended coagulated state can be obtained, and is not particularly limited. Generally, the concentration of the raw material in the konnyaku paste is not uniformly set. For example, in the case of a konnyaku paste having a raw material concentration of 2 to 3% by mass, it is important to perform the addition such that calcium hydroxide has a concentration around 0.1% by mass in the konnyaku. Further, it is preferable to add the alkaline coagulant solution in a range of 10 to 20% by mass with respect to the weight of the konnyaku paste. Further, it is possible to adjust the texture by performing the addition such that calcium hydroxide has a concentration around 0.06 to 0.08% by mass in the konnyaku or has a concentration around 0.12 to 0.16% by mass. Furthermore, generally, the alkaline coagulant is added to konnyaku paste such that pH of the konnyaku produced using the alkaline coagulant according to the present invention is preferably in a range of 11 to 12.3, and more preferably 11.5 to 12.0. Furthermore, by a conventional methods, it is possible to obtain “Namazume” konnyaku products without filler water, or to obtain a packaged konnyaku product by filling a packaging container with the konnyaku and a filler water.

The inventors have found that the alkaline aqueous solution containing the non-reducing sugar and calcium hydroxide in the dissolved state is useful also as the filler water. Thus, the inventors have concluded that the alkaline aqueous solution containing the non-reducing sugar and calcium hydroxide in the dissolved state maintains the state of the aqueous solution, which is very stable under a temperature condition of 50° C. or lower, and can be suitably used as the filler water; and that the alkaline aqueous solution is appropriate also for the filling under a temperature condition in a wide range including a high temperature because no precipitation occurs under a temperature condition of 70° C. for 1 to 2 days in the case of a solution having sugar concentration of 1 to 3% by mass or for several days in the case of a solution having sugar concentration of 4% by mass or more; and that the alkaline aqueous solution can be suitably used as a filler water, when a konnyaku or a processed konnyaku product such as “Shirataki” is filled in an packaging container.

In the case where the conventional calcium hydroxide (lime) suspension is used as the filler water, the supernatant of the calcium hydroxide (lime) suspension is used as the filler water, and such filler water as a calcium hydroxide solution has a concentration of about 0.15% by mass. In contrast, the filler water according to the present invention has a good preservation stability, and by the coexistence with the non-reducing sugar, the concentration of calcium hydroxide in the filler water can be set to a higher concentration than that in the conventional filler water containing calcium hydroxide. Therefore, it is possible to reduce transportation weight and cost by the weight saving of the product, and to achieve an efficient use of calcium hydroxide as a component of the filler water.

The amount of sugar to be added for preparation of an alkaline aqueous solution as the filler water may be that allowing an intended dissolution concentration of calcium hydroxide to be achieved. However, when the concentration of the sugar solution is 35%, the added calcium hydroxide sometimes agglutinates and becomes adhesive mass. Therefore, the concentration in water may be selected from a range of 1 to 30% by mass, preferably 5 to 20%.

The concentration of calcium hydroxide in the dissolved state, which is contained in the alkaline aqueous solution as the filler water, may be that allowing an intended function and preservation stability as the filler water to be obtained. However, when the calcium hydroxide concentration to be dissolved in the sugar solution is exceeding 6.5%, formation of the insoluble calcium hydroxide and the solid-liquid separation become difficult, in some cases. Therefore, it is preferable to be a range of 0.25% to 6.5% by mass.

The alkaline aqueous solution as the filler water may have an alkaline property allowing an intended function as the filler water to be obtained. For example, the alkaline aqueous solution can have an alkaline property with a pH that is selected from a range of 12 to 13, preferably 12.0 to 12.8, more preferably 12.3 to 12.8.

The filler water according to the present invention can be suitably used for sealing of at least one product of konnyaku products and processed konnyaku products such as “Shirataki” in a container. The konnyaku products and the processed konnyaku products sealed in the container is not limited. Examples of the konnyaku products and processed konnyaku products include various konnyaku products and processed konnyaku products described above as those produced using the alkaline coagulant according to the present invention.

The filler water according to the present invention can be used for filling in the packaging of a konnyaku product or a processed konnyaku product produced using the alkaline coagulant according to the present invention. Furthermore, the filler water according to the present invention can be used also as the filler water when the konnyaku or processed konnyaku product by a conventional method is sealed in a packaging container.

The alkaline coagulant including the aqueous solution of sugar and calcium hydroxide according to the present invention has an advantage in that the solid component is not generated during the preservation and, thus, the preservation stability is excellent. The alkaline coagulant can be treated by an aseptic filtration. The alkaline coagulant after the aseptic filtration treatment can be suitably used for production of konnyaku in an aseptic manner. An aseptic filtration apparatus that has been used for aseptic treatment of liquid can be used for the present aseptic filtration treatment.

An example of the aseptic konnyaku production method comprises mixing, in an aseptic manner, a konnyaku paste sterilized by heat sterilization and an alkaline coagulant after aseptic filtration treatment; and performing a heating treatment after an aseptic packaging.

Another example of the method comprises blending at least one of soy milk, tofu, seafoods, meat, seaweeds, condiments, spices, extracts, aroma chemicals, etc., to the konnyaku paste describe above, sterilizing the konnyaku paste by the above heat sterilization, and, thereafter, producing an aseptic processed konnyaku product by the same method and procedure as described above. The aseptic processed konnyaku product in this case has pH sometimes becoming lower than 10.0.

The heat sterilization method for the konnyaku paste may be that allowing an intended sterilization effect to be obtained, and a heat sterilization method selected from known sterilization methods can be used. The aseptic filtration treatment method for the alkaline coagulant may be a method allowing an intended aseptic filtration treatment to be achieved, and a filter with a pore diameter depending on the intention can be selected and used. The aseptic mixing of the sterilized konnyaku paste and the aseptically treated alkaline coagulant after the aseptic treatment, and the filling of the mixture thereof in the packaging container can be performed in known environment and by a known apparatus with means for prevention of microbial pollution.

An example of the production method for the aseptic konnyaku comprises
sterilizing a konnyaku paste by a heat sterilization treatment at 130 to 140° C. for 30 seconds to 200 seconds using an indirect heating type heat exchanger after a konnyaku refined powder (special grade powder) in 33 to 35 times its volume of water at 25° C.,
mixing, in an aseptic manner, the konnyaku paste and an aseptic alkaline coagulant (an aqueous solution containing 0.6 to 1% by mass of calcium hydroxide and having a granulated sugar concentration of 5 to 7% by mass) after an aseptic filtration treatment with a filter (cellulose-mixed ester type membrane filter manufactured by Toyo Roshi Kaisha Ltd.) having a pore size of 0.2 μm, at a ratio (mass ratio) of 1 aseptic alkaline coagulant to 9 aseptic konnyaku paste, and
packaging the mixture in a soft packaging member subjected to an aseptic treatment, in an aseptic manner, and performing a heat coagulation treatment at 80° C. for about 30 minutes.

In the heat sterilization treatment of the sterilized konnyaku paste, it is preferable that the treatment time be set to a short time in the case of a high temperature condition and be set to a long time in the case of a low temperature condition.

As described above, since the konnyaku can be filled in the packaging container in the aseptic state, it is no more necessary to rely on a high pH by an alkaline agent for biostatic effects. As a result, the flexibility for setting of the pH range is widen and various kinds of seasoning and flavoring can be used. Therefore, it is deemed that it is possible to supply konnyaku products responding to a variety of cooking applications, and that the possibility of product development can expand.

Thus, the present invention saves the labor of the pretreatment that is troublesome for consumers, such as removal of smell and astringent or harsh taste, and the present invention paves the way for wide utilization of konnyaku as a more familiar foodstuff.

### EXAMPLES

The present invention will be described below in further detail, with examples.

### Example 1

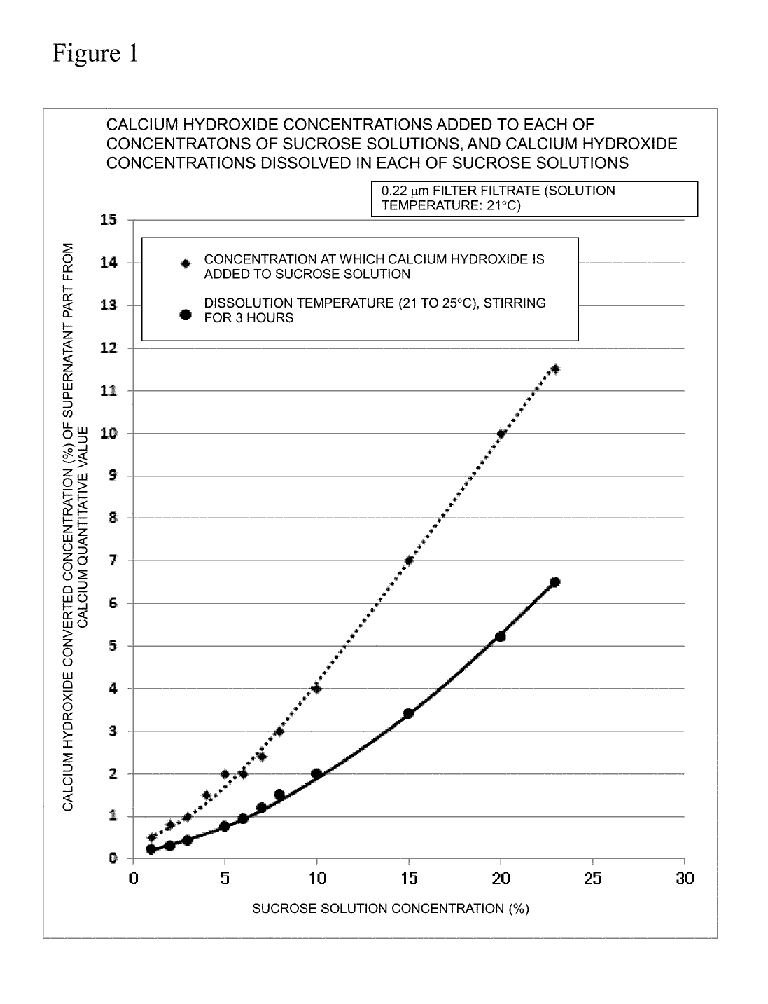

Aqueous solutions (500 g) having various sugar concentrations shown in FIG. 1 were prepared at room temperature (conditions of 20 to 23° C. or 21 to 25° C., the same applies hereinafter), using granulated sugar as the sugar. An excessive amount of lime (calcium hydroxide: manufactured by Inoue Calcium Corporation, trade name: “Kontaro”) was added to each sugar aqueous solution, and mixed. The mixture thus obtained was stirred and further mixed at room temperature for 3 hours. Then, after the mixture was left at room temperature overnight and the supernatant part was separated. The separated part was filtrated using a filter (manufactured by Toyo Roshi Kaisha Ltd., type: DISMC-25SS) having a pore size of 0.22 μm. The Ca-ion concentration of the obtained filtrate was measured with an atomic absorption photometry (Shimadzu Corporation, Type: AA-7000), and the measured values were converted to the calcium hydroxide concentrations, respectively. The obtained result was shown as • (black circles) in FIG. 1. Each solution was left at 20 to 50° C., but no generation of insoluble substances was observed.

### Example 2

The sugar concentration was set to 6% by mass, and the calcium hydroxide concentrations of the supernatant parts at two different preparation temperatures (room temperature or cooling temperature: 9 to 11° C.) were evaluated in the same manner as Example 1. The obtained result is shown in FIG. 2.

### Example 3

The sugar concentration was set to 20% by mass, and the calcium hydroxide concentrations of the supernatant parts at room temperature was evaluated in the same manner as Example 1. The obtained result is shown in FIG. 3.

### Example 4

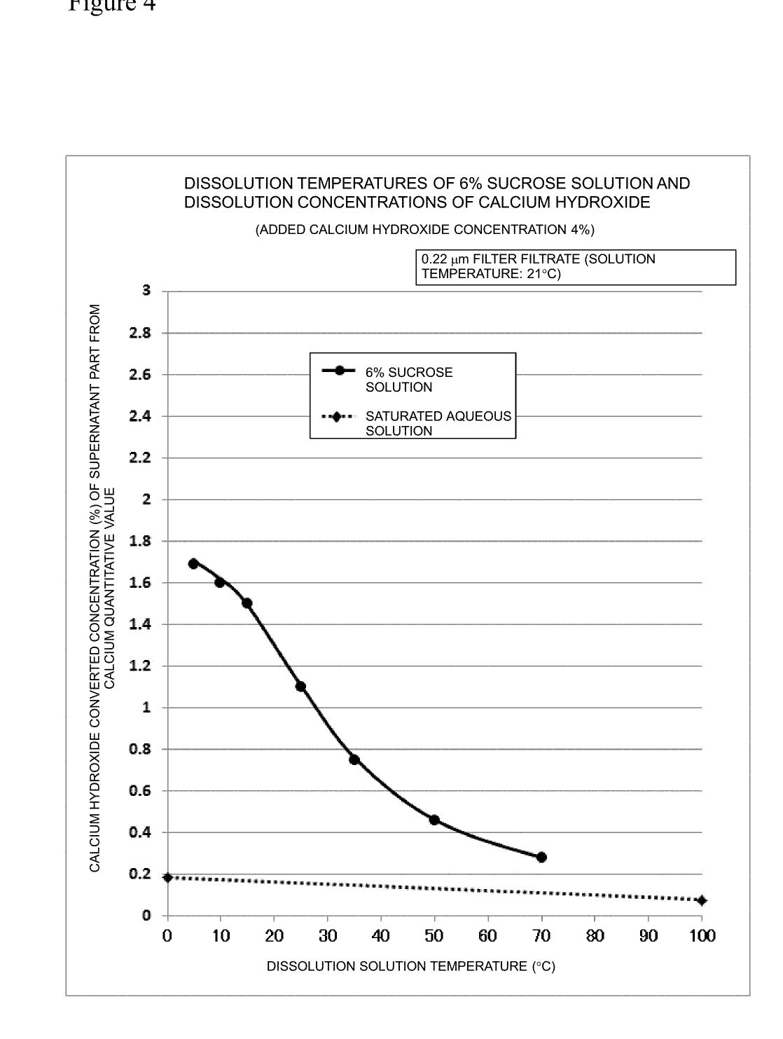

The sugar concentration was set to 6% by mass, and the calcium hydroxide concentrations of the supernatant parts at a preparation temperature was evaluated in the same manner as Example 1. The obtained result is shown in FIG. 4. The “saturated aqueous solution” in FIG. 4 is the supernatant part of the lime suspension.

### Example 5

In 175 g of water at 25° C., 5 g of a konnyaku refined powder (special grade powder) was dissolved and stirred for 8 minutes. Thereafter, the mixture thus obtained was left at room temperature for 90 minutes, so that a konnyaku paste was prepared. The konnyaku paste thus obtained was mixed with 20 g of a lime suspension prepared using a lime (calcium hydroxide: manufactured by Inoue Calcium Corporation, trade name: “Kontaro”) as the alkaline coagulant. Their mixture was kneaded for 60 seconds, and was packaged with a heat-resistant film. The packaged mixture was heated at 80° C. for 30 minutes, and, thereafter, was left overnight, so that a konnyaku was obtained. As the lime suspension, suspensions having various lime blending ratios were individually used.

Separately, 5 g of a konnyaku refined powder (special grade powder) was dissolved in 175 g of water at 25° C., and the solution was stirred for 8 minutes. Thereafter, the mixture thus obtained was left at room temperature for 90 minutes, so that a konnyaku paste was prepared. The obtained konnyaku paste was mixed with an alkaline coagulant as an aqueous solution (sucrose-lime solution) including calcium hydroxide dissolved in the sugar solution. Their mixture was kneaded for 60 seconds, and was packaged with a heat-resistant film. The packaged mixture was heated at 80° C. for 30 minutes, and, thereafter, was left overnight, so that a konnyaku was obtained. As the alkaline coagulant, using granulated sugar and a lime (calcium hydroxide: manufactured by Inoue Calcium Corporation, trade name: “Kontaro”), aqueous solutions having various concentrations of sugar and calcium hydroxide shown in Table 1 were prepared, and these alkaline coagulants were individually used.

TABLE 1

| | Sucrose Lime Solution | | | |
|---|---|---|---|---|
| | | Calcium | Calcium hydroxide | |
| | Sucrose | hydroxide | (% by mass) in | pH of |
| Coagulant | (% by mass) | (% by mass) | Konnyaku | Konnyaku |
| 1 | 5.0 | 0.75 | 0.075 | 11.00 |
| 2 | 6.2 | 1.06 | 0.105 | 11.79 |
| 3 | 7.0 | 1.20 | 0.12 | 12.00 |
| 4 | 8.0 | 1.50 | 0.15 | 12.07 |
| 5 | 9.1 | 1.80 | 0.18 | 12.20 |
| 6 | 13.9 | 3.15 | 0.315 | 12.38 |
| 7 | 18.5 | 4.80 | 0.48 | 12.49 |

Each konnyaku thus obtained was grinded, and pH of each grinded material was measured. The obtained result was shown in FIG. 5.

### Example 6

A packaged konnyaku product sealed in a packaging container was placed at room temperature, such that the temperature of the konnyaku became room temperature. After the konnyaku was brought out by opening, the konnyaku was cut to a size of 1.5 cm×3 cm immediately, and in this state, a sensory evaluation by panelists was performed.

The packaged konnyaku product was produced by the following method:

To 20.75 g of a konnyaku refined powder (special grade powder), 726.25 g of water at 25° C. was added, and the mixture was sufficiently stirred, and, thereafter, the mixture was left for 1 hour and 30 minutes, so that a konnyaku paste was prepared. Thereafter, 83 g of a lime suspension (“Kontaro”) having a concentration of 1% was added, the kneading was quickly performed, and the packaging was performed for 200 g of the paste, using a heat-resistant film. The packaged paste was heated at 80° C. for 30 minutes, and thereafter, was left overnight, so that the coagulation was completed.

Further, 150 g of calcium hydroxide powder (“Kontaro”) was added to 500 g of a 6% by mass granulated sugar solution (23° C.), and their mixture was stirred at room temperature (23° C.) for 3 hours in advance, and, thereafter, leaving the mixture at room temperature overnight to prepare a supernatant fraction. The supernatant fraction was filtered using a 0.22 μm filter (manufactured by Toyo Roshi Kaisha Ltd., type: DISMC-25SS) and obtain a filtrate solution.

A konnyaku was prepared by the exact same procedure as that using the lime suspension as describe above, except for the use of 83 g of a sucrose-lime solution resulting from diluting the above filtrate solution to 1.1 times (concentration in terms of calcium hydroxide: 1%) with water.

The konnyaku thus obtained had pH 11.73 in the case using the lime suspension, and that had pH 11.78 in the case using the sucrose-lime solution, and they were nearly the same. The result of the sensory test is shown in Table 2.

TABLE 2

| Sample | |
|---|---|
| Name | Sensory Evaluation Result (10 Panelists) |
| Sucrose | Weak Konnyaku smell (7 panelists) |
| Lime | Weak astringent or harsh taste (8 panelists) |
| Solution | Little bitter taste (2 panelists) |
| | Slight sweet taste feeling (2 panelists) |
| | Moderate elasticity, and easily-bitten texture (10 panelists) |
| Lime | Strong Konnyaku smell (7 panelists) |
| Suspension | Strong astringent or harsh taste (8 panelists) |
| | Strong bitter taste (2 panelists) |
| | Pungent sense remains as aftertaste (5 panelists) |
| | Moderate elasticity, and easily-bitten texture (10 panelists) |

1. An alkaline coagulant for konnyaku production, comprising an alkaline solution comprising sugar, calcium hydroxide as an alkaline component for coagulation, and water, wherein the sugar and the calcium hydroxide are dissolved in the water, and the sugar is non-reducing sugar.

2. The alkaline coagulant according to claim 1 wherein the non-reducing sugar is contained from 1% to 30% by mass, and calcium hydroxide is contained from 0.25% to 6.5% by mass.

3. The alkaline coagulant according to claim 1, wherein the alkaline coagulant has a pH of 12.0 to 12.8.

4. The alkaline coagulant according to claim 1, wherein the non-reducing sugar is sucrose.

5. The alkaline coagulant according to claim 4, wherein the sucrose is granulated sugar.

6. The alkaline coagulant according to claim 1, wherein the alkaline coagulant is an alkaline coagulant treated by aseptic filtration.

7. A production method for a konnyaku, comprising a step of mixing a konnyaku paste with an alkaline coagulant and coagulating the konnyaku paste by heating, wherein the alkaline coagulant according to claim 1 is used as the alkaline coagulant.

8. The production method for a konnyaku according to claim 7, further comprising a step of filling the produced konnyaku and filler water into a packaging container.

9. The production method for a konnyaku according to claim 8, wherein the filler water comprises an alkaline solution containing sugar, calcium hydroxide as an alkaline component for coagulation, and water, wherein the sugar and the calcium hydroxide are dissolved in the water, and the sugar is non-reducing sugar.

10. The production method for a konnyaku according to claim 9, wherein the filler water contains 1% to 30% by mass of non-reducing sugar and 0.25% to 6.5% by mass of calcium hydroxide.

11. The production method for a konnyaku according to claim 9, wherein the filler water has a pH of 12.0 to 12.8.

12. The production method for a konnyaku according to claim 9, wherein the non-reducing sugar contained in the filler water is sucrose.

13. The production method for a konnyaku according to claim 12, wherein the sucrose is granulated sugar.

14. The production method for a konnyaku according to claim 7, wherein the alkaline coagulant is an alkaline coagulant treated by aseptic filtration, and the konnyaku is produced in an aseptic manner.

15. The production method for a konnyaku according to claim 14, further comprising a step of mixing, in an aseptic manner, a konnyaku paste sterilized by a heating treatment which is used as the konnyaku paste, with the alkaline coagulant treated by aseptic filtration, packaging the konnyaku paste in an aseptic manner, and coagulating the packaged konnyaku paste by heating.

16. A konnyaku product that is produced by the production method according to claim 7.

17. A packaged konnyaku product, comprising at least one of a konnyaku and a processed product thereof, and a filler water, filled in a container for packaging, wherein the filler water comprises an alkaline solution containing sugar, calcium hydroxide as an alkaline component for coagulation, and water, wherein the sugar and the calcium hydroxide are dissolved in the water, and the sugar is non-reducing sugar.

18. The packaged konnyaku product according to claim 17, wherein the konnyaku or the processed konnyaku product is a konnyaku or a processed product thereof by a conventional method.

19. The packaged konnyaku product according to claim 17, wherein the konnyaku or the processed konnyaku product is a konnyaku or a processed konnyaku product that is produced using the alkaline coagulant for konnyaku production, comprising an alkaline solution comprising sugar, calcium hydroxide as an alkaline component for coagulation, and water, wherein the sugar and the calcium hydroxide are dissolved in the water, and the sugar is non-reducing sugar.

20. The packaged konnyaku product according to claim 17, wherein the filler water contains 1% to 30% by mass of non-reducing sugar and 0.2 to 6.5% by mass of calcium hydroxide.

21. The packaged konnyaku product according to claim 17, wherein the filler water has a pH of 12.0 to 12.8.

22. The packaged konnyaku product according to claim 17, wherein the non-reducing sugar contained in the filler water is sucrose.

23. The packaged konnyaku product according to claim 22, wherein the sucrose is granulated sugar.
